(19) United States
(12) Patent Application Publication
(10) Pub. No.: US 2013/0295530 A1
(43) Pub. Date: Nov. 7, 2013

(54) NUTRITION EDUCATION GAME

(71) Applicant: PREVENT CHILD ABUSE-NEW JERSEY, New Brunswick, NJ (US)

(72) Inventors: Monica TOWNSEND, Middlesex, NJ (US); Patricia M. MOJTA, Allentown, NJ (US); Caitlin M. PERRY, Norfolk, MA (US)

(73) Assignee: PREVENT CHILD ABUSE-NEW JERSEY, New Brunswick, NJ (US)

(21) Appl. No.: 13/804,055

(22) Filed: Mar. 14, 2013

Related U.S. Application Data
(60) Provisional application No. 61/642,051, filed on May 3, 2012.

(51) Int. Cl. G09B 19/00

(52) U.S. Cl. CPC G09B 19/0092
USPC 434/127

(57) ABSTRACT

The disclosed subject matter is directed to an educational game designed to teach children about healthy food choices and the importance of foods from different food groups to a healthy diet. In one embodiment the game comprises a representation of a plate that is divided into different colored segments where each colored segment represents a different food group, and game pieces are designed to represent different foods. The game involves placing the game pieces onto the different colored plate segments of the correct food group and making a meal having a healthy balance of different foods. The game can be played as a group or individually. Different formats for the game include, but are not limited to, a board game, a hanging wall chart, a floor game, and a computer game.

### CROSS-REFERENCE TO RELATED APPLICATION

This application claims benefit under 35 U.S.C. §119(e) of U.S. Provisional Patent Application No. 61/642,051, entitled “NUTRITION EDUCATION GAME,” filed on May 3, 2012, which is expressly hereby incorporated by reference herein in its entirety.

### COPYRIGHT NOTICE

The disclosure herein contains material which is subject to copyright protection. The copyright owner has no objection to the facsimile reproduction by anyone of the patent document or patent disclosure as it appears in the U.S. Patent and Trademark Office, patent file or records, but otherwise reserves all copyright rights whatsoever.

### TECHNICAL FIELD

The disclosed subject matter relates generally to educational games and methods for playing educational games to teach children about proper nutrition.

### BACKGROUND

Children across the nation face complex risk factors that may lead to obesity. These include poor eating habits, poor understanding of nutrition and lack of physical activity. What is needed is a fun, appealing and interactive way to instruct children on proper nutrition and physical exercise through learned associations (e.g., associating food groups and physical activities with different colors).

### SUMMARY

The disclosed subject matter is directed to an educational game designed to teach children about healthy food choices and the importance of foods from different food groups to a healthy diet. In one embodiment the game comprises a representation of a plate that is divided into different colored segments where each colored segment represents a different food group, and game pieces are designed to represent different foods. The game involves placing the game pieces onto the different colored plate segments of the correct food group and making a meal having a healthy balance of different foods. The game can be played as a group or individually. Different formats for the game include, but are not limited to, a board game, a hanging wall chart, a floor game, and a computer game.

The disclosed subject matter can include an educational game apparatus for teaching nutrition to children. The game apparatus can include a playing surface including one or more plate areas, wherein each plate area is divided into one or more colored segments, and wherein the color of each colored segment represents a food group. The game apparatus can further include a plurality of game pieces, wherein each game piece comprises both (i) a representation of a food item and (ii) a colored portion, wherein the color of the colored portion of each game piece represents the food group to which the food item belongs, enabling a player to select and place a game piece on a plate area corresponding to one of the food group of the food item represented on the game piece or the color present on the colored portion of the game piece.

In one aspect, the educational game apparatus further comprises a receptacle for holding the game pieces, wherein the receptacle is one of a box, a basket, envelope or a pouch.

In one aspect, the educational game apparatus further comprises a graphical representation of a physical activity, wherein each physical activity represented on the game apparatus is presented in association with at least one of a particular food group and a particular color.

In one aspect, the representation of the physical activity is provided on at least one of the playing surface and the game pieces.

In one aspect, each game piece having a representation of a food from the same food group has the same physical activity represented.

In one aspect, each game piece having the same color on the colored portion has the same physical activity represented,

In one aspect, the educational game apparatus further comprises a supplemental instruction manual comprising one or more of: (i) instructions for playing the game and (ii) educational materials relating to nutrition.

In one aspect, the educational game apparatus comprises an attachment device for attaching the game piece to the plate area on the playing surface.

In one aspect, the playing surface of the educational game apparatus comprises a hanging device.

In one aspect, the playing surface of the educational game apparatus is configured for use on one or more of the ground, on a floor, on a table, or on another substantially horizontal surface.

In one aspect, the playing surface of the educational game apparatus is configured to represent one or more of a picnic cloth, a table cloth, a tray, a table, or a kitchen counter.

In one aspect, one or more colored segments of the educational game apparatus are releasably attached to the one or more plate areas.

In one aspect, the playing surface of the educational game apparatus comprises plate areas of different sizes.

In one aspect, the relative size of each colored segment representing each food group of the educational game apparatus is proportional to the amount of food from each food group that the USDA recommends should be eaten daily in the USDA MyPlate.

In one aspect, the plate areas of the educational game apparatus each comprise colored segments, each colored segment having a different color.

In one aspect, one food from one of grain, protein, fruit, vegetable, and dairy food groups of the educational game apparatus are represented on the plurality of game pieces.

In one aspect, each of the game pieces of the educational game apparatus comprises at least two surfaces and the representation of the food item and the colored portion are both present on same surface of the game piece.

The disclosed subject matter can include an educational game apparatus for teaching nutrition to children. The game apparatus can further include a playing surface including: (i) a first plate area divided into four colored segments, wherein each colored segment has a different color, and the color of each colored segment represents a different food group selected from protein, grain, vegetables, and fruit, and wherein the size of each colored segment is proportional to the amount of food from that food group that should be eaten in a healthy diet, and (ii) a second plate area comprising only a single colored segment, wherein the color of the colored segment represents a the dairy food group, and wherein the size of the colored segment is proportional to the amount of food from the dairy food group that should be eaten in a healthy diet. The game apparatus can also include a plurality of game pieces, wherein each game piece comprises both (i) a representation of a food item, and (ii) a colored portion, wherein the color of the colored portion of each game piece represents the food group to which the food item belongs, enabling a player to select and place a game piece on a plate area corresponding to one of the food group of the food item represented on the game piece or the color present on the colored portion of the game piece.

In one aspect, the relative size of each colored segment representing each food group of the educational game apparatus is proportional to the amount of food from each food group that the USDA recommends should be eaten daily in the USDA MyPlate guidelines.

The disclosed subject matter can include a method of playing a nutritional educational game. The method can further include selecting a game piece from a receptacle, wherein the game piece comprises both (i) a representation of a food item and (ii) a colored portion, wherein the color of the colored portion of each game piece represents the food group to which the food item belongs. The method can further include determining either (i) which food group the food item represented on the game piece belongs to, or (ii) which color is present on the colored portion of the game piece. The method can further include placing the game piece on a colored plate segment of a plate area on a playing surface, wherein the colored plate segment has been designated to correspond to either (i) the food group of the food item represented on the game piece, or (ii) the color present on the colored portion of the game piece. The method can further include performing a pre-determined physical activity, wherein the physical activity has been designated to correspond to the food group or the color of the selected game piece, and (e) repeating (a) through (d) until either (i) all of the game pieces in the receptacle have been placed on a colored plate segment, or (ii) there is no space to place more game pieces on a colored plate segment.

### BRIEF DESCRIPTION OF THE DRAWINGS

FIG. 1 provides a graphical representation of one format of a game according to an embodiment of the disclosed subject matter, in which a playing surface having five plate segments and graphical representations of different physical activities that can be performed in conjunction with the game is illustrated.

FIG. 2 provides a graphical representation of one format of a game according to an embodiment of the disclosed subject matter, in which a playing surface having five plate segments with game pieces attached is illustrated.

FIG. 3 provides a graphical representation of one format of a game with game pieces and a receptacle for game pieces according to an embodiment of the disclosed subject matter, in which a playing surface having five plate segments and graphical representations of different physical activities that can be performed in conjunction with the game is illustrated.

### DETAILED DESCRIPTION

The disclosed subject matter provides an educational game, including both a game apparatus and a method of playing using the game apparatus. The game is particularly well-suited for educating children, and in particular young children, about nutrition in a fun setting. The game can be played by a single player or by multiple players. The game typically has a game leader, such as a teacher, parent, or caregiver, who explains the rules of the game to the game players, structures the playing of the game, and throughout the game educates the game players about nutrition.

In one general embodiment of the disclosed subject matter, the game comprises having the players pick different game pieces that represent different food items and place those game pieces on a playing surface that has plate areas represented on it. The plate areas represented on the playing surface are typically divided into multiple different segments, each segment having a different color with each segment/color representing a different food group. For example, in one embodiment the plate areas are based on those provided by the USDA in its MyPlate guidelines which reflect the USDA's new dietary guidelines. The players place their selected game piece onto the plate segment of the correct food group. In some embodiments the game pieces, in addition to having a representation of a food item, also have a colored portion—the color of which corresponds to the colored segments used to represent the different food groups on the plate areas. This strengthens the learned associations in the game. If the game is played by a single player, the player can pick one game piece after another and continue placing them on the correct colored plate segment, preferably under the guidance of a teacher, parent, or caregiver. If the game is played by multiple players, for example in a class room setting or during group play, the players can take turns selecting game pieces, or a spinner wheel or some other suitable system can be used to assign turns to the players. In some embodiments when a player places a game piece on a colored plate segment, the player, or group of players, also engage in a physical activity, with different physical activities being associated with each food group/color. For example, in one embodiment the players make muscle-flexing motions with their arms whenever a food from the protein food group is placed on a plate area, or whenever the game leader mentions the protein food group. Including these physical activities can strengthen the learned associations between the various foods and food groups.

The game described herein can fulfill several educational objectives. It can teach children about: (1) nutritious foods, (2) the categorization of foods into food groups, (3) the importance of eating a variety of nutritious foods every day, (4) the positive and negative impacts of different foods on health and well-being, (5), the importance of physical activity in addition to a healthy diet, (6) colors and color matching (particularly for younger players), (7) and the importance of taking turns and following instructions. The game also provides a useful tool for addressing several other key areas of child development, including development of fine and gross motor skills, social and emotional development, cognitive development, and language development.

In some embodiments the disclosed subject matter provides a physical game apparatus for playing the nutritional education game described herein. In some alternative embodiments the game can also be configured for use on a computer or similar electronic device. For example, the game can be provided in the form of an “app” for use on smart phones, tablet computers, and the like. In that case the game comprises virtual representations of the various physical parts of the game apparatus described herein, and the game pieces and other components of the game apparatus are manipulated in a virtual manner, for example using a mouse to drag and drop game pieces.

### I. Game Apparatus

In one embodiment the disclosed subject matter provides an educational game apparatus for teaching nutrition to children, the game apparatus comprising: (a) a playing surface including one or more plate areas, wherein each plate area is divided into one or more colored segments, and wherein the color of each colored segment represents a food group, and (b) a plurality of game pieces, wherein each game piece comprises both (i) a representation of a food item and (ii) a colored portion, wherein the color of the colored portion of each game piece represents the food group to which the food item belongs. The game apparatus may also comprise a receptacle for holding the game pieces, and/or supplemental materials that can include instructions for playing the game and educational information that the game leader can use during the game. The game apparatus may also comprise instructions for, or a graphical representation of, physical activities to be performed by the players that are associated with foods from different food groups. These instructions, and/or the graphical representations, can be provided in the supplemental materials, on the playing surface, or on the game pieces.

### A. Playing Surface

In one embodiment the game apparatus of the disclosed subject matter comprises a playing surface. The playing surface itself may be made of any suitable material, including, but not limited to cloth, cardboard, paper, laminated paper, wood, metal, plastic, and the like. In some embodiments the playing surface is configured to represent a picnic blanket, a table cloth, a tray, a table, or a kitchen counter. For example, in one embodiment the playing surface may have certain design elements printed on or otherwise applied to its surface to make it resemble a picnic blanket.

In one embodiment the playing surface is configured to be hung on a wall, door, or other substantially vertical surface. In such embodiments the playing surface can be hung using a device such as a hook, clip, string or wire. In another embodiment the playing surface is configured for use on the ground, on the floor, on a table, or on another substantially horizontal surface. In another embodiment the playing surface is configured so that it can stand on a surface without hanging, for example using a stand such as a picture frame stand.

In some embodiments the playing surface may comprise written instructions regarding different physical activities that can be performed in conjunction with the game, indicating which physical activity is associated with each food group. In other embodiments the playing surface may comprise graphical representations of different physical activities that can be performed in conjunction with the game, indicating which physical activity is associated with each food group.

### B. Plate Areas

In one embodiment the playing surface comprises one or more “plate areas.” These plate areas may be permanently marked on the playing surface, for example by printing, or may be attached to the playing surface in a non-permanent manner. For example, in one embodiment the plate areas can be releasably attached to the playing surface using any suitable attachment device including, but not limited to, Velcro, buttons, hooks, clips, tape, magnets, and the like. The plate areas can be in any suitable form. For example, the plate areas in an embodiment of the disclosed subject matter can be designed to resemble a plate, cup, or bowl. The plate areas can be flat 2-dimensional representations on the playing surface or may be 3-dimensional structures—more closely representing the structure of a real plate, cup, or bowl. The plate areas can also be of any desired size. The plate areas can be of uniform size or there may be plates of varying sizes, for example large dinner sized plates, small side plates, and so on.

In one embodiment the plate areas on the playing surface are divided into one or more segments, with each segment having a different color and each color being associated with a different food group (such as the grain, protein, fruit, vegetable, or dairy food groups). In some embodiments there may be five segments on each plate area—one each for each of the five food groups. However, in other embodiments there may be four segments on each plate area—one for each of four of the five food groups—and there may be a separate colored plate for the remaining food group. This embodiment reflects the USDA's MyPlate guidelines, which are based on the USDA's new dietary guidelines. Similarly, in another embodiment there may be three segments on each plate area—one for each of three of the five food groups—and there may be two separate colored plates for the remaining two food groups. In some alternative embodiments, a multitude of different plates may be used instead of different plate segments, for example there may be five different colored plate areas, with each plate area having a different color and each color being associated with a different food group. In embodiments where the plate areas are divided into multiple different colored segments, the segments can be wedged shaped or any other suitable shape. In some embodiments the relative sizes of each of the different colored segments reflects the amounts of each food group that the USDA recommends should be eaten as part of a healthy diet, for example in the USDA's MyPlate guidelines which reflect the USDA's new dietary guidelines.

In one embodiment the plate areas comprise an attachment device, which can be used to attach the game pieces to the plate areas. Any suitable attachment device can be used including, but not limited to, Velcro, buttons, hooks, clips, tape, magnets, and the like. The attachment device can be used in a reversible way, such that the game pieces can be attached to and removed from the plate areas on the playing surface repeatedly.

In some embodiments the plate areas may comprise written instructions regarding different physical activities that can be performed in conjunction with the game, indicating which physical activity is associated with each food group. In other embodiments the plate areas may comprise graphical representations of different physical activities that can be performed in conjunction with the game, indicating which physical activity is associated with each food group.

### C. Game Pieces

In one embodiment the game apparatus of the disclosed subject matter comprises a plurality of game pieces wherein each game piece comprises a representation of a food item. The game pieces may be made of any suitable material, including, but not limited to cloth, cardboard, paper, laminated paper, wood, plastic, metal, and the like. The representation of the food items on each game piece can be in any suitable form. For example, in one embodiment each game piece may be made in the 3-dimensional shape of the food item. In another embodiment the game piece may be a flat piece having a graphical representation of the food item printed on or otherwise attached to one or more surface. In one embodiment the game pieces are sized and/or shaped such that they do not present a choking hazard for small children, for example by making the game pieces sufficiently large in size.

In some embodiments, each game piece has a representation of only a single food item. The game apparatus comprises a large number of different food items represented on the different game pieces. For example, there may be more than 25, or more than 50, or more than 75, or more than 100, or more than 150, or more than 200 different food items represented on the plurality of game pieces. Use of a large variety of different food items on the game pieces will facilitate learning about a large variety of different and unusual foods, including foods that the players may not have previously been familiar with.

In some embodiments each game piece also comprises a colored portion, wherein the color of the colored portion of each game piece represents the food group to which the food item represented on the game piece belongs. This can facilitate and further reinforce the learning experience. In addition, for younger players that may have difficulty recognizing the different food items on the game pieces, or categorizing them into food groups, the game can be used as a color matching game.

In one embodiment the game pieces comprise an attachment device, which can be used to attach the game pieces to the plate areas on the playing surface. Any suitable attachment device can be used including, but not limited to, Velcro, buttons, hooks, clips, tape, magnets, and the like. The attachment device operates in a reversible manner, such that the game pieces can be attached to and removed from the plate areas on the playing surface repeatedly.

In some embodiments the game pieces may comprise written instructions regarding different physical activities that can be performed in conjunction with the game, indicating the physical activity that is associated with the food item/food group represented on each game piece. In other embodiments the game pieces may comprise graphical representations of different physical activities that can be performed in conjunction with the game, indicating which physical activity is associated with the food item/food group represented on each game piece.

### D. Receptacle for Game Pieces

In some embodiments the game apparatus of the disclosed subject matter also comprises a receptacle in which the game pieces are stored before they are placed on the plate areas. This receptacle can be in any suitable form, without limitation. For example, the receptacle can be in the form of a box, a basket, envelope, or a pouch. The receptacle can be designed to stand apart from the playing surface or it can be attached to the playing surface. Where it is attached to the playing surface it can be permanently attached or releasably attached. Any suitable attachment device can be used including, but not limited to, Velcro, buttons, hooks, clips, tape, magnets, and the like. The attachment device functions in a reversible manner, such that the receptacle can be attached to and removed from the playing surface repeatedly.

### II. Supplemental Materials

In some embodiments the game apparatus of the disclosed subject matter also comprises supplemental materials comprising information such as instructions for playing the game and educational materials relating to nutrition. In some embodiments the supplemental materials may comprise written instructions regarding different physical activities that can be performed in conjunction with the game, indicating the physical activity that is associated with particular food items/food groups. In other embodiments the supplemental materials may comprise graphical representations of different physical activities that can be performed in conjunction with the game, indicating which physical activity is associated with particular food items/food groups.

Supplemental educational materials that can be provided with the game apparatus of the disclosed subject matter include, but are not limited to: (i) discussion points—to facilitate in engaging the children in a discussion about the game and their food choices, including discussion points relating to foods that the children like to eat, new foods that they would like to try, healthy alternatives to junk food, and healthy snacking, (ii) suggested reading materials relating to healthy diets, including for example: I Can Eat a Rainbow by Annabel Karmel, Eating the Alphabet by Lois Ehlert, Gregory, the Terrible Eater by Mitchell Sharmat, and Good Enough to Eat by Lizzy Rockwell, (iii) educational materials relating to, for example, the MyPlate dietary guidelines from the USDA, appropriate portion sizes for preschoolers, how to read a food label, staying active as a family, healthy shopping on a budget, healthy snacking, and sample meal plans and recipes, and (iv) one or more magnets, stickers, posters, postcards or similar devices having a representation of the USDA MyPlate dietary guidelines that can be placed in a location suitable for viewing even when the game is not being played (such as on a fridge or other suitable surface in a kitchen or dining area) in order to reinforce the educational objectives of the game.

Further embodiments of the disclosed subject matter are also described in the following examples, which are provided for illustrative purposes and are not limiting.

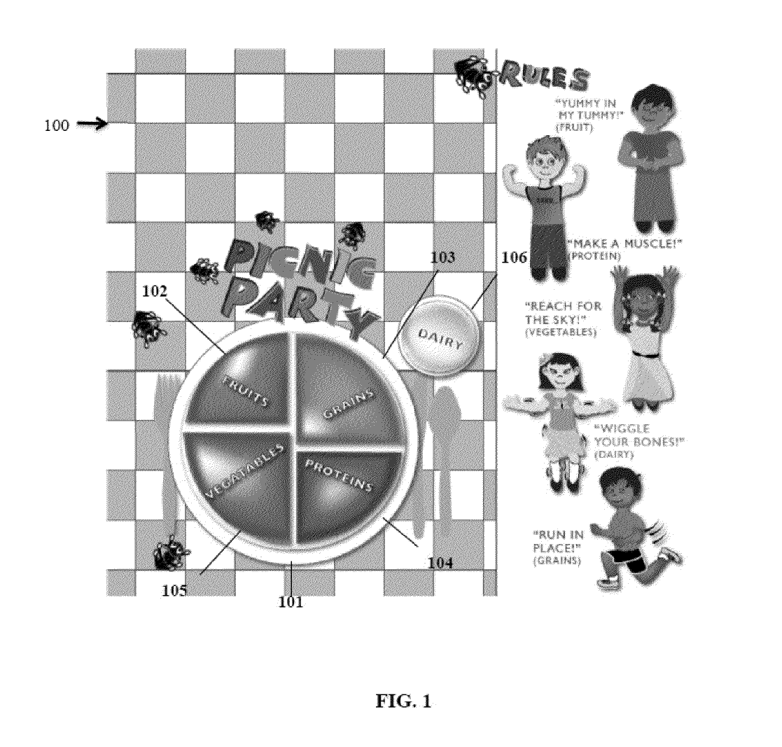

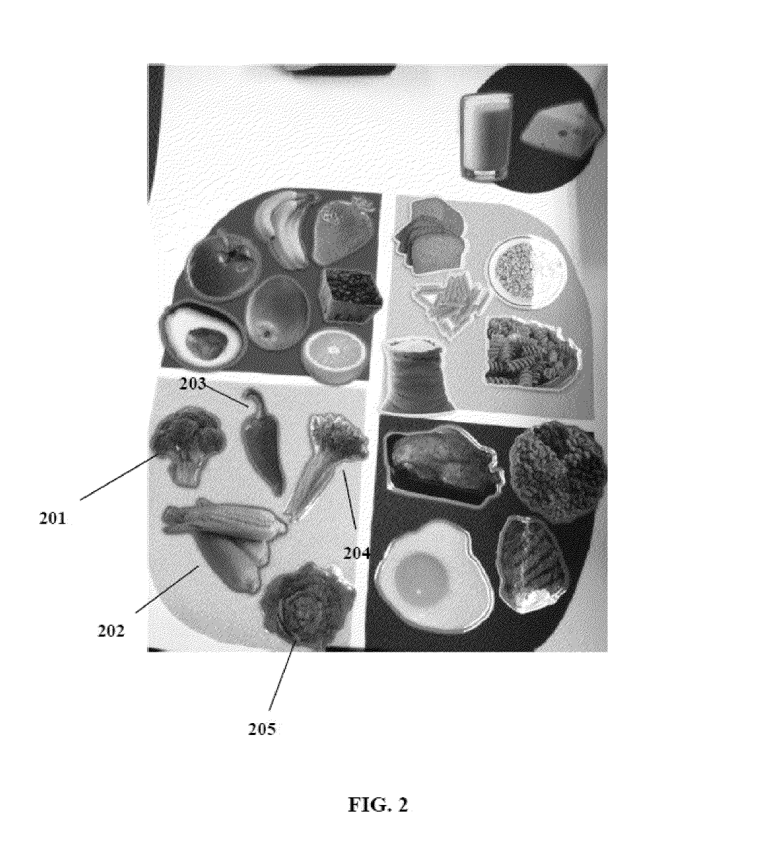

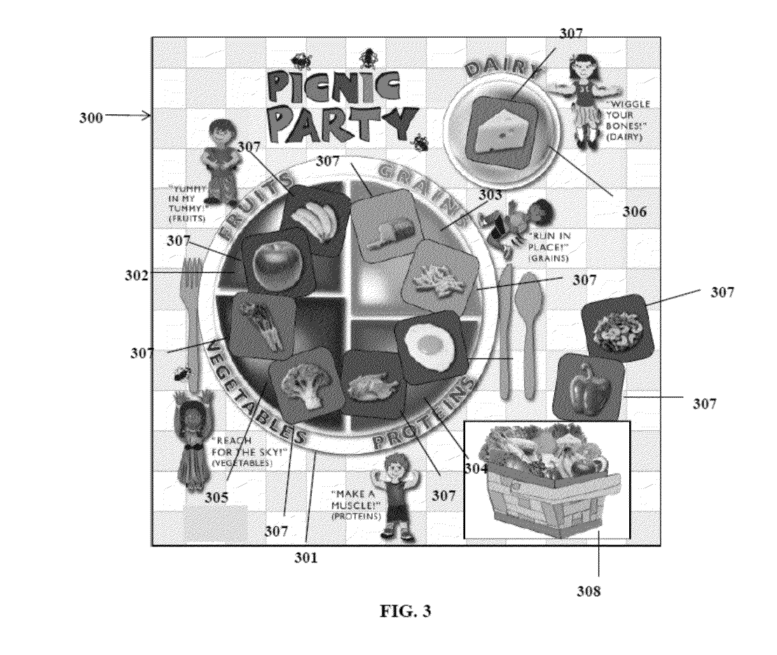

One embodiment of the game apparatus of the disclosed subject matter provides a group play activity that is particularly well-suited to an educational setting, such as circle time or story time for preschool and kindergarten-aged children. In this exemplary embodiment the playing surface of the game is provided in the form of a “picnic party” poster to be placed on a wall, table top, easel, or some other suitable location within reach of the children. FIGS. 1 and 3 illustrates such exemplary playing surfaces 100 and 300, each having one large plate area 101 and 301 divided into four colored segments 102-105 and 302-305, and each having one small plate area 106 and 306 having a single colored segment. The red colored segments 102 and 302 represent the fruit food group, the orange colored segments 103 and 303 represent the grain food group, the green colored segments 104 and 304 represent the vegetable food group, the purple colored segments 105 and 305 represent the protein food group, and the blue colored segments 106 and 306 (present on the separate small plate/cup) represent the dairy food group. The game pieces each comprise a representation of a food item. The game pieces are placed on the plate segment of the corresponding food group. For example, in the embodiment shown in FIG. 2, broccoli 201, corn 202, pepper 203, carrots 204, and lettuce 205 game pieces have been placed on the green plate segment which has been designated to correspond to the vegetable food group. In an exemplary embodiment, as illustrated in FIG. 3, the food game pieces 307 can be stored within a “picnic basket” 308, on the poster or nearby within reach of the children.

At the beginning of the game the game leader (e.g. teacher) explains to the children that the purpose of the game is to learn about healthy eating. The game leader explains how the game works, for example, that that every colored segment on the one or more plate areas on the “picnic party” poster may be filled with food of a particular food group. For example, that:
(i) the orange plate segment(s) are to be filled with foods that fall within the grain food group (such as bread, pasta, and rice),
(ii) the red plate segment(s) are to be filled with foods that fall within the fruit food group (such as apples, oranges, and grapes),
(iii) the purple plate segment(s) are to be filled with foods that fall within the protein food group (such as chicken, steak, eggs, and beans),
(iv) the green plate segment(s) are to be filled with foods that fall within the protein food group (such as carrots, broccoli, and spinach), and
(v) the blue plate segment(s) are to be filled with foods that fall within the dairy food group (such as milk, cheese, and yogurt.)

These plate segment colors are exemplary. Different colors can be used for different food groups as would be understood by those of skill in the art. Also the use of plate segments is exemplary. Different colored bowls or cups can be used for some or all of the food groups as would be understood by those of skill in the art.

While explaining the rules of the game, the game leader can also explain to the children about the different food groups. For example, the teacher can explain that grains are good because they give us lots of energy so we can run around and play, fruits are full of vitamins that make us healthy, protein is really important because it helps us grow strong muscles, vegetables are good for us because they also contain lots of vitamins and minerals that make us healthy, and dairy is good for us because it helps us grow strong teeth and bones. The game leader can also explain to the children that the players may also perform different physical activities during the game. For example, the game leader can explain to the players that they may:
(i) run in place when a grain food is selected or when the game leader talks about grain foods, “because grains give us energy,”
(ii) stand up and rub their tummies when a fruit food is selected or when the game leader talks about fruit foods, “because fruits are yummy in our tummies,”
(iii) stand up and flex the arm muscles when a protein food is selected or when the game leader talks about protein foods, “because protein makes our muscles grow,”
(iv) stand up and reach as high as they can when a vegetable food is selected or when the game leader talks about vegetable foods, “because vegetables help us grow big and tall,”
(v) stand up and wiggle our bones when a dairy food is selected or when the game leader talks about dairy foods, “because dairy foods make our bones strong.”

The game leader may then select one child to come to the front of the room to select a food game piece from the basket. The child can say what category the food belongs in, or can show the group to ask for help. (Note: in one embodiment, all of the food pieces have a colored backing to match the group in which it belongs.) The child places the food piece on the appropriate plate segment on the poster. After the food piece is selected and placed on the poster, the game leader can instruct the children to stand up and do the action associated with the food category (e.g. run in place, rub tummy, etc.).

The children then take turns, repeating these steps until all of the food game pieces have been used or the plate areas are full. The game leader may also ask the children if they can name any foods from each group, or ask them which foods from each group they like to eat.

Another embodiment of the game apparatus of the disclosed subject matter provides a variation of the above game that is particularly well-suited to a younger age group, (for example, around 3 years old). The children may sit in a group like they would for circle time or story time. The Picnic Party poster may be set up on a wall, table top, or easel within reach of the children. All of the food game pieces may be stored within the picnic basket on the poster. The game leader can explain that the purpose of the game will be to learn about all the kinds of foods that we should eat to be healthy. The game leader can also explain to the children that every color on the plate represents a kind of food that we should eat. For example, the game leader might explain that “the orange part of the plate is for GRAINS. Grains are foods like bread, pasta, and rice. Grains are good for us because they give us lots of energy so we can run around and play. Now, let's all stand up and run in place! We are going to do this every time we talk about grains. The red part of the plate is for FRUIT. Fruits are foods like apples, oranges, and grapes. Fruits are full of vitamins that make us healthy, and they also taste really good! Now, let's all stand up and rub our tummies because fruits are Yummy in Our Tummies! We are going to do this every time we talk about fruits. The purple part of the plate is for PROTEIN. Protein includes foods like chicken, steak, eggs, and beans. Protein is really important because it helps us grow strong muscles. Not, let's all stand up and make a muscle with our arms! We are going to do this every time we talk about protein. The green part of the plate is for VEGETABLES. Vegetables are foods like carrots, broccoli, and spinach. Vegetables are good for us because they help us grow big and tall. Now, let's all stand up and reach as high as we can! We are going to do this every time we talk about vegetables. Last, the blue cup is for DAIRY. Dairy includes foods like milk, cheese, and yogurt. Dairy is good for us because it helps us grow strong bones. Now, let's all stand up and Wiggle Our Bones! We are going to do this every time we talk about dairy.”

Next the game leader can select a game piece from the picnic basket and hold it up for the players to see. The game leader can ask the players to call out the name of the food if they know it, ask the players what color is on the back of the game piece, and then place the game piece on the corresponding colored section of the poster. After the game piece is placed on the poster, the game leader can instruct the children to stand up and do the action associated with the food category (e.g., run in place, rub tummy, etc.). The game leader can repeat this process until all of the game pieces have been used up or all of the plate segments are full. For younger players that are not able to categorize foods into food groups the game leader can focus on matching the colored portion of the game pieces to the corresponding colored plate segment. The purpose is for the children to see that they should eat a variety of different types of foods daily.

We claim:

1. An educational game apparatus for teaching nutrition to children, the game apparatus comprising:
(a) a playing surface including one or more plate areas, wherein each plate area is divided into one or more colored segments, and wherein the color of each colored segment represents a food group, and
(b) a plurality of game pieces, wherein each game piece comprises both (i) a representation of a food item and (ii) a colored portion, wherein the color of the colored portion of each game piece represents the food group to which the food item belongs, enabling a player to select and place a game piece on a plate area corresponding to one of the food group of the food item represented on the game piece or the color present on the colored portion of the game piece.

2. The educational game apparatus according to claim 1, further comprising a receptacle for holding the game pieces, wherein the receptacle is one of a box, a basket, envelope or a pouch.

3. The educational game apparatus according to claim 1 further comprising a graphical representation of a physical activity, wherein each physical activity represented on the game apparatus is presented in association with at least one of a particular food group and a particular color.

4. The educational game apparatus according to claim 4, wherein the graphical representation of the physical activity is provided on at least one of the playing surface and the game pieces.

5. The educational game apparatus according to claim 4, wherein each game piece having a representation of a food from the same food group has the same physical activity represented.

6. The educational game apparatus according to claim 4, wherein each game piece having the same color on the colored portion has the same physical activity represented.

7. The educational game apparatus according to claim 1, further comprising a supplemental instruction manual comprising one or more of: (i) instructions for playing the game and (ii) educational materials relating to nutrition.

8. The educational game apparatus according to claim 1, comprising an attachment device for attaching the game piece to the plate area on the playing surface.

9. The educational game apparatus according to claim 1, wherein the playing surface comprises a hanging device.

10. The educational game apparatus according to claim 1, wherein the playing surface is configured for use on one or more of the ground, on a floor, on a table, or on another substantially horizontal surface.

11. The educational game apparatus according to claim 1, wherein the playing surface is configured to represent one or more of a picnic cloth, a table cloth, a tray, a table, or a kitchen counter.

12. The educational game apparatus according to claim 1, wherein the one or more colored segments are releasably attached to the one or more plate areas.

13. The educational game apparatus according to claim 1, wherein the playing surface comprises plate areas of different sizes.

14. The educational game apparatus according to claim 14, wherein the relative size of each colored segment representing each food group is proportional to the amount of food from each food group that the USDA recommends should be eaten daily in the USDA MyPlate.

15. The educational game apparatus according to claim 1, wherein the plate areas each comprise colored segments, each colored segment having a different color.

16. The educational game apparatus according to claim 1, wherein one food from one of grain, protein, fruit, vegetable, and dairy food groups are represented on the plurality of game pieces.

17. The educational game apparatus according to claim 1, wherein each of the game pieces comprises at least two surfaces, and wherein the representation of the food item and the colored portion are both present on same surface of the game piece.

18. An educational game apparatus for teaching nutrition to children, the game apparatus comprising:
(a) a playing surface including:
(i) a first plate area divided into four colored segments, wherein each colored segment has a different color, and the color of each colored segment represents a different food group selected from protein, grain, vegetables, and fruit, and wherein the size of each colored segment is proportional to the amount of food from that food group that should be eaten in a healthy diet, and
(ii) a second plate area comprising only a single colored segment, wherein the color of the colored segment represents a the dairy food group, and wherein the size of the colored segment is proportional to the amount of food from the dairy food group that should be eaten in a healthy diet, and
(b) a plurality of game pieces, wherein each game piece comprises both
(i) a representation of a food item, and
(ii) a colored portion, wherein the color of the colored portion of each game piece represents the food group to which the food item belongs, enabling a player to select and place a game piece on a plate area corresponding to one of the food group of the food item represented on the game piece or the color present on the colored portion of the game piece.

19. An educational game apparatus according to claim 19, wherein the relative size of each colored segment representing each food group is proportional to the amount of food from each food group that the USDA recommends should be eaten daily in the USDA MyPlate guidelines.

20. A method of playing a nutritional educational game comprising:
(a) selecting a game piece from a receptacle, wherein the game piece comprises both (i) a representation of a food item and (ii) a colored portion, wherein the color of the colored portion of each game piece represents the food group to which the food item belongs,
(b) determining either (i) which food group the food item represented on the game piece belongs to, or (ii) which color is present on the colored portion of the game piece,
(c) placing the game piece on a colored plate segment of a plate area on a playing surface, wherein the colored plate segment has been designated to correspond to either (i) the food group of the food item represented on the game piece, or (ii) the color present on the colored portion of the game piece, and
(d) performing a pre-determined physical activity, wherein the physical activity has been designated to correspond to the food group or the color of the selected game piece, and
(e) repeating (a) through (d) until either (i) all of the game pieces in the receptacle have been placed on a colored plate segment, or (ii) there is no space to place more game pieces on a colored plate segment.
